(19) United States
(12) Patent Application Publication
(10) Pub. No.: US 2002/0021689 A1
(43) Pub. Date: Feb. 21, 2002

(54) Method and apparatus for transparent internet mobility management

(76) Inventors: Barry R. Robbins, San Diego, CA (US); Mark E. Muri, San Diego, CA (US)

Correspondence Address: Pillsbury Madison & Sutro LLP, Intellectual Property Group, 50 Fremont Street, San Franacisco, CA, 94120-7880, US

(21) Appl. No.: 09/753,138

(22) Filed: Dec. 29, 2000

Related U.S. Application Data
(60) Provisional application No. 60/173,733, filed on Dec. 30, 1999.
(60) Provisional application No. 60/202,228, filed on May 5, 2000.
(60) Provisional application No. 60/202,229, filed on May 5, 2000.

(51) Int. Cl. H04L 12/66

(52) U.S. Cl. 370/352; 370/466

(57) ABSTRACT

A method and apparatus for achieving seamless, Internet Protocol (IP) wireless station mobility by using an Internet Protocol (IP) router to receive and classify IP packets and route them to their desired destination based on these classifications as the IP host moves between networks. The use of this method and apparatus provides a transparent network to facilitate Internet mobility management.

### RELATED APPLICATIONS

This application claims the benefit of co-pending U.S. Provisional Application Ser. No. 60/173,733 filed Dec. 30, 1999, and U.S. Provisional Application Nos. 60/202,228 and 60/202,229 both filed on May 5, 2000.

### BACKGROUND

1. Field of the Invention

Aspects of the present invention relate in general to a method and apparatus for transparent Internet mobility management. In particular aspects of the present invention relate to a method and apparatus for use in wireless Internet Protocol (IP) networks to achieve seamless, wireless station mobility.

2. Description of the Related Art

At present, the wireless Internet industry includes a number of industry segments offering differing forms of solutions to accomplish wireless communications with IP networks. Some of these segments include Packet Radio Networks, Cellular (or PCS) Networks, Wireless Local Area Networks (LAN), and Local Multipoint Distribution Service (LMDS). The solutions offered by each of these segments allow wireless stations to communicate with networks, such as Wide Area Networks (WANs) or LANs, without the requirement of fixed lines.

Nevertheless, each of these present wireless industry segments fail to achieve and provide seamless wireless services such that a wireless station may achieve full mobility across a large geographic area while receiving uninterrupted IP network service. Furthermore, most of these segments have attempted to achieve true mobile service through the use of protocols or procedures that limit their simple and widespread introduction into diverse wireless IP networks. For instance most of these segments require registers to do handshaking as the wireless host moves between different networks or subnets resulting in the inoperability of the segments with conventional transmission control protocol/internet protocol (TCP/IP) communications.

FIG. 12 shows a standard network 1100 and illustrates this type of conventional IP transmission. FIG. 12 shows a router 1105 that provides the Wide Area Network (WAN) 1105 and four subscriber subnets 1135-1150. One or more wireless Access Points (AP) 1155-1180 are deployed on each subnet. This network is limited in subscriber mobility, due to the fact that handoff and roaming between access points may only occur among access points on the same subnet or between subnets through the use of Mobile IP or other proprietary protocols among access points 1155-1180. There are many disadvantages to the use of these protocols including: long handoff latency, long and variable bearer traffic latency, heavy processing load on the access points 1155-1180 and mobile hosts, and heavy messaging traffic for signaling across both the wireless and LAN media.

### BRIEF DESCRIPTION OF THE DRAWINGS

FIG. 1 shows an embodiment of an expanded functional block diagram of a CPU.

FIG. 2 shows a diagram of an embodiment the flow of operation of the MR according to one aspect of the invention.

FIG. 3 shows an illustrative diagram of the of Internet protocol mobility achievable with use of embodiments of the MR of the current invention.

FIGS. 4A and 4B show embodiments of the Overall Processing Flow the MR of the current invention.

FIG. 5 illustrates a flow chart of an embodiment of the Receive Input Stage of the current invention.

FIG. 6 is a flow chart of an embodiment of the Consider Application Resolution Protocol (ARP) Table Update Stage.

FIG. 7 shows a flow chart of an embodiment of the Consider Route Table Update Stage of the current invention.

FIG. 8 is a flow chart of an embodiment of the Receive Forwarding Stage of the current invention.

FIG. 9 shows a flow chart of and embodiment of the Link Layer Packet Processing Stage of the current invention.

FIG. 10 illustrates a flow chart of an embodiment of the Route to Destination Stage of the current invention.

FIG. 11 shows a flow chart of an embodiment of the Forward to Stack Stage of the current invention.

FIG. 12 (PRIOR ART) shows a standard network requiring proprietary protocols to transfer mobile IP hosts between access points.

FIGS. 13-14 illustrate embodiments of transparent pass-through implementations of the MR in an IP network.

FIG. 15 shows embodiment of a subscriber-side implementation of the MR in an IP network.

FIG. 16 illustrates an embodiment of replacement router implementation of the MR in an IP network.

FIGS. 17-22 illustrate embodiments of multi-board and mulit-MR configurations of the previous implementations of the MR.

### DETAILED DESCRIPTION

Because wireless technology enables movement without the constraint of fixed lines, it is appreciated that the next hurdle to widespread implementation of such technology is to provide for the free movement of wireless stations such that a wireless station will not incur negative consequences, such as interruption of service or low data rates, during roaming. What is needed is a method and apparatus enabling the transparent handoff between broadband wireless IP networks so that a wireless station can be mobile. The present invention now will be described more fully hereinafter with reference to the accompanying drawings, in which embodiments of the invention are shown. This invention may however, be embodied in many different forms and should not be construed as limited to the embodiments set forth herein. These embodiments are merely provided so that this disclosure will be thorough and complete, and will fully convey the scope of the invention to those skilled in the art. Like numbers refer to like elements throughout.

Embodiments of the present invention are described below with reference to block diagrams, flowcharts and illustrations of the method and apparatus. It will be understood that each block of the block diagrams and combinations of blocks in the block diagrams, can be implemented by computer program instructions. These computer program instructions may be loaded onto a general purpose computer, special purpose computer, or other programmable data processing apparatus to produce a machine, such that the instructions which execute on the computer or other programmable data processing apparatus implements the functions specified in the illustrative examples described below. These computer program instructions may also be stored in a computer-readable memory that can direct a computer or other programmable data processing apparatus to function in a particular manner, such that the instructions stored in the computer-readable memory produce an article of manufacture which implements the functions and acts specified herein.

The computer program instructions may also be loaded onto a computer or other programmable data processing apparatus to cause a series of operational acts to be performed on the computer or other programmable apparatus to produce a computer implemented process such that the instructions which execute on the computer or other programmable apparatus provide acts for implementing the functions specified herein. Accordingly, blocks of the block diagrams support structures that perform the specified functions and acts, combinations of acts for performing the specified functions and program instructions performing the specified acts. It will also be understood that each block of the block diagrams and combinations of blocks in the block diagrams, as well as the functions specified by the blocks herein, can be implemented by special purpose hardware-based computer systems which perform the specified functions or acts, or combinations of special purpose hardware and computer instructions.

Disclosed is a Mobility Router (MR) for insertion in wireless networks, where the MR enables automatic roaming and transparent handoff for wireless stations in an IP packet based wireless network. The MR enables the transparent handoff of a wireless station without requiring new protocols or procedures to be implemented by wireless networks or wireless stations taking advantage of its functions, thereby making the wireless station a mobile station. The MR accomplishes this transparency by working with basic TCP/IP, as is well known in the art. Furthermore, utilizing the MR embodiment of the present invention results in minimal latency during handoff as compared to conventional wireless networks.

The MR provides translation between entities at different access points in a wireless network. Therefore, the MR can resolve communication differences existing between two different mobile stations. Therefore, the mobile station user benefits from being able to access wireless networks without having to undergo the time-consuming and all-too-often daunting task of reconfiguring her terminal in accordance with network specific configurations. Another function of the MR is to reduce the latency and transmission time of data transmitted from one mobile station to another mobile station in the network, due to its location in the network and its ability to monitor the existing location of entities in the network. Finally, the MR enables the hand-off of mobile stations between wireless access points within a Local Area Network (LAN), or between separate LANs, such that service and session will not be interrupted, allowing greater mobility.

Generally, a Wireless Internet Mobility Router (MR) according to the present invention enables IP-based Mobility Management, Service Management and Subscriber Management to diversify broadband wireless packet networks, including Wireless LAN, Broadband PCS, Wireless ATM and Fixed Wireless such as LMDS/MMDS and BWA. Mobility Management is a set of functionalities that provide for Automatic Roaming, Handoff, Accounting (Rating), Authentication, and Security (Encryption). Service Management is a set of functionalities that provide for Bandwidth Management (rate limiting, Quality of Service), ISP/ASP Service Selection (tunneling, content-based routing), Virtual ISP/ASP Support (wholesale/resale model) and Network Based VPN.

The MR embodiment of the present invention can be utilized in Wireless Local Area Networks (WLANs), Broadband PCS, and Wireless ATM, and BWA/LMDS to enable these wireless networks to become mobile wireless networks. Although wireless IP networks lack the requirement of lines or wires for communication, such networks do not enable the seamless transition from one wireless access point to another without loss of service or session. Loss of session occurs when a wireless station is unable to receive any transmission via the wireless network. For example, loss of session occurs when a dial-up user communicating with the Internet via a conventional telephone modem loses the telephone connection. If the user were downloading data, the downloading would be terminated such that the user would have to reconnect to the Internet and reinitiate the downloading. On the other hand, loss of service occurs where there is a temporary interruption of communication, which does not permanently interrupt the communication between the wireless network and wireless station. For instance, where a user loses service during the downloading of data the service may be reestablished and the downloading continued such that the user does not lose data or is required to reconnect to the network. Whereas loss of service is analogous to a complete disconnection, loss of session is similar to a hold or a time out.

According to one aspect of the present invention, the inclusion of the MR into broadband wireless IP networks results in mobile wireless terminals which will not suffer from loss of session or interruption of service regardless of the movement of the mobile station from one wireless network to another. Thus, a subscriber can freely roam from one wireless access point to another or from one local area network to the next, while maintaining an ongoing and uninterrupted network session. This is accomplished via the inclusion of a MR into broadband wireless networks.

MR embodiments of the present invention identify the location and existence of other MRs in the network, so that a range of addresses at which a mobile station may be located are predefined. When a mobile station enters a wireless access point to which a particular MR is connected, the MR will recognize the user and communicate the location of the user to the other MRs. Therefore, the hand-off function of a mobile station from one wireless access point to another is facilitated because the location of the mobile station is determined quickly and registered with each MR. Furthermore, a tunneling method enables the hand-off of mobile stations in wide area network roaming and the mobility of a wireless station in a WAN.

According to some embodiments the present invention, a MR may comprise one or more mainboards mounted in a chassis, each offering two or more LAN and/or WAN interfaces. The MR's LAN/WAN interfaces may be provisional on the mainboard(s), daughter card(s), and/or dedicated LAN/WAN board(s). Furthermore, a MR-based packet mobility network may be provided as a single platform handling multiple interfaces, or as multiple MRs linked by a LAN/WAN. Although the MR can be physically embodied in many different fashions, the MR typically includes a controller and a memory device in which software is stored that defines the operational characteristics of the MR. Alternatively, the MR can be embedded within another network device, such as a router within a wireless IP network.

As will be appreciated by one of ordinary skill in the art, the embodiments may be implemented as a method, a data processing system, or a computer program product. Accordingly, the embodiments may take the form of an entirely hardware embodiment, an entirely software embodiment, a firmware embodiment, or an embodiment combining software and hardware aspects. Furthermore, the embodiments may take the form of a computer program product on a computer-readable storage medium having computer-readable program code stored in the storage medium. Any suitable computer readable storage medium may be utilized including hard disks, CD-ROMs, optical storage devices, or magnetic storage devices.

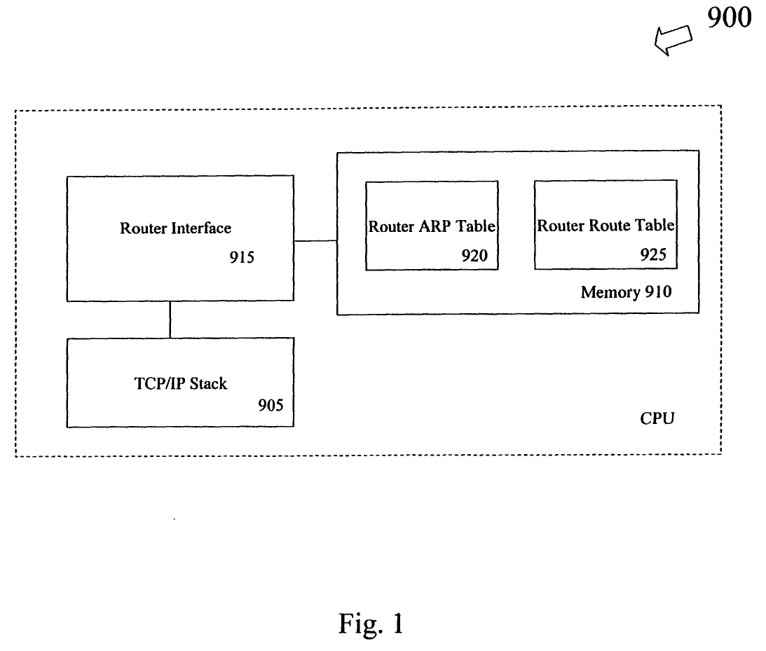

FIG. 1 is a hardware embodiment of the MR showing an expanded functional block diagram of CPU 900. As shown in FIG. 1, central processing unit 900 is functionally comprised of a router interface 915, a TCP/IP stack, and a memory comprising a router ARP table and a router route table. The router interface and TCP/IP stack 905 and router interface 915 facilitate the connection to the Internet. The ARP table 920 and route table 910 located in memory 910. The ARP stores IP packet classifications, while the route table stores updated routing information that is sent to other nodes on the network to insure accurate IP packet delivery.

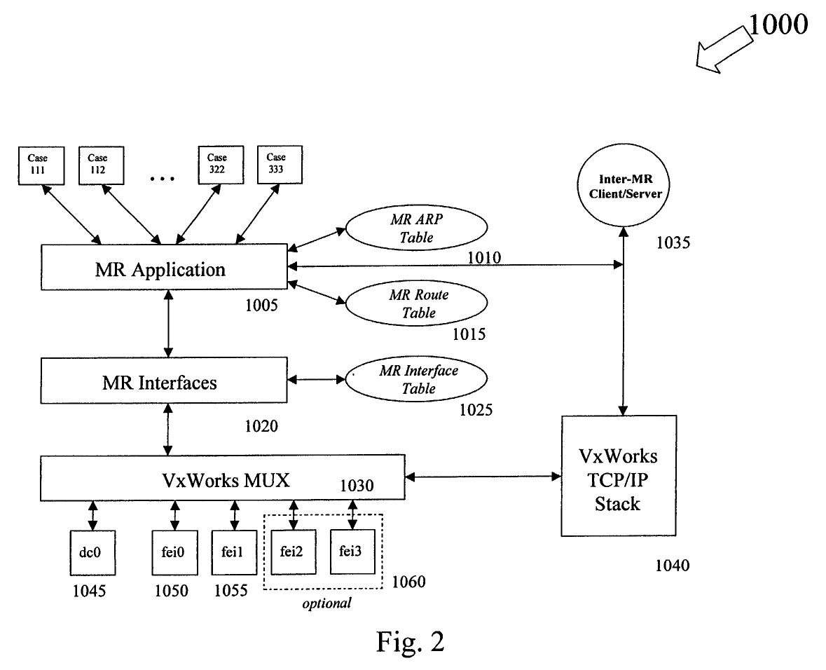

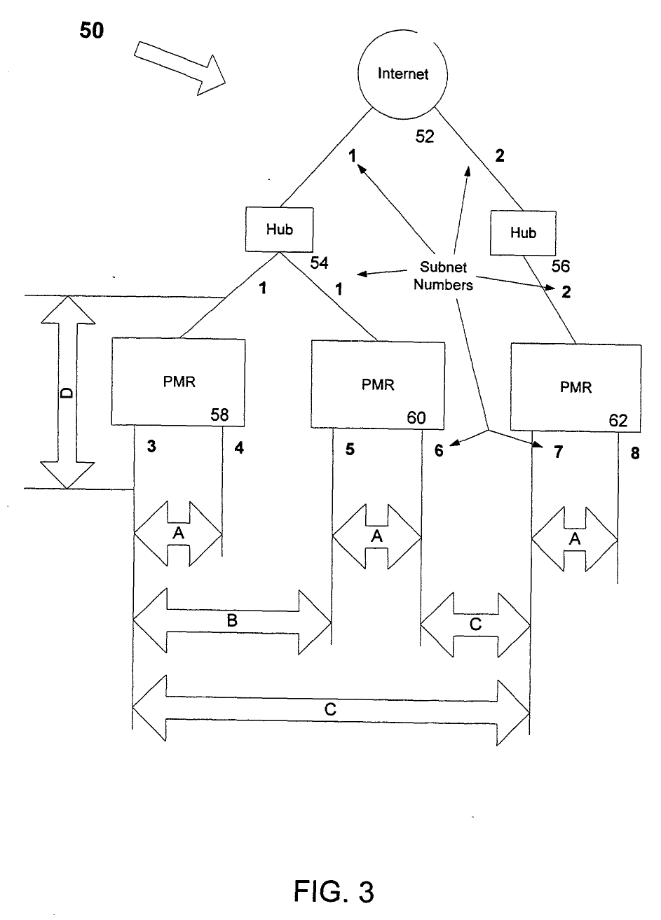

FIG. 2 illustrates an embodiment MR according to one aspect of the present invention. The MR includes at least one Routing Table 1015, Interface Table 1025, MR application 1005, and TCP/IP Stack and hardware platform 1040, which contains hardware such as a processor and memory to process and store the applications that facilitate routing of the IP packets. The MR also comprises at least one Interface 1020, and Multiplexer 1030. The embodiment also includes front-end interfaces (FEI) 1050-1060 to receive that data packets. The functions of each of these components will be appreciated with reference to the illustrative examples of the MR, described hereinafter.

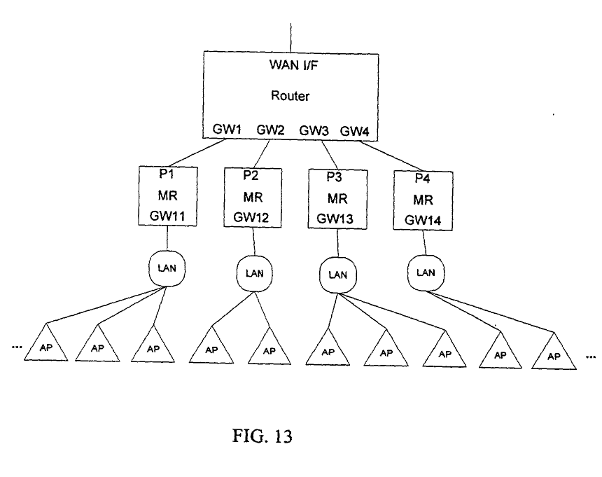

As shown in FIGS. 13-17 the MR can take on at least three different personalities according to its placement in the network and its relationship with existing conventional routers. It should be appreciated that the networks and respecting MR locations in these figures are intended to be for illustrative purposes only, and do not limit the manner and locations in which MRs of the present invention may be placed. Rather, those skilled in the art will appreciate that the MR of the present invention can be inserted at any number of points in a network to effectuate the functions discussed herein.

In FIG. 13, the MR 1305 is introduced in a transparent fashion in an existing network based on a conventional router. The conventional router 1110 need not be aware of the introduction of the MR 1305. Neither does it require reconfiguration. The MR 1305 substitutes for each of the original gateway (GW) interfaces from the subscriber point of view (GW1-GW4), 1115-1130 and presents a transparent LAN network from the existing conventional router's 1110 point of view (P1-P4). Because the MR 1305 knows that GW1-GW4 1115-1130 were the original LAN gateways, the mobile hosts do not need to be reconfigured. Also, because the MR 1305 represents each entire LAN access point (AP) subscriber population (P1-P4), the existing conventional router does not need to be reconfigured.

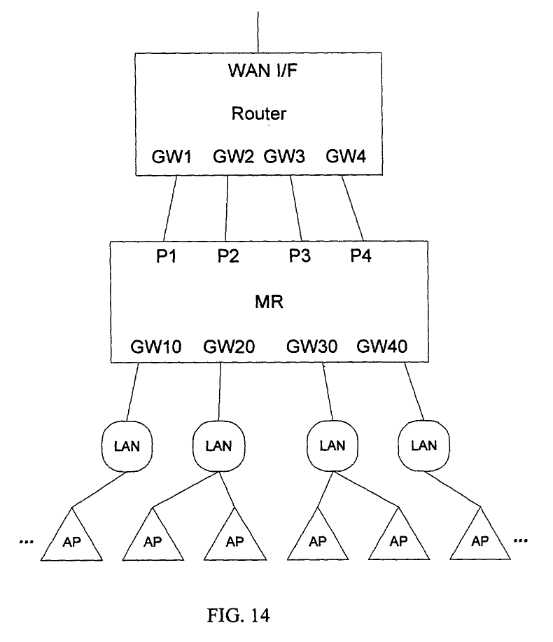

In FIG. 14, the MRs 1305A-D substitute for all the original gateway interfaces 1115-1130 from the subscriber point of view (GW1-GW4), and presents a transparent LAN from the existing conventional router's 1110 point of view (P1-P4). This is equivalent to the above example in FIG. 13 with the addition of multiple LANs per MR. Therefore, according to this illustrative example, the MR includes virtual gateways (or Interfaces, as in FIG. 13) mimicking default gateways within the WAN. Additionally, the virtual gateways appear to the WAN as the LANs, so that neither the WAN or LAN identify the MR as being located in between (double blind concept). This allows the MR to be placed into the network with minimum cost and risk, and with one MR having a number of virtual gateways therein.

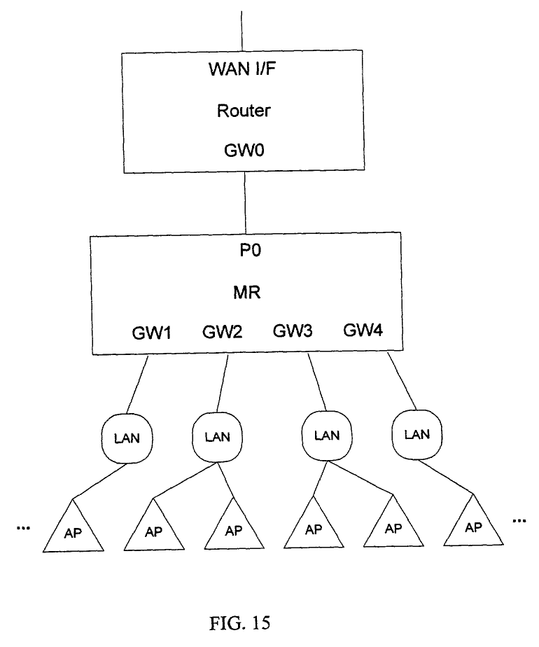

In FIG. 15, the MR 1305 is introduced as a replacement subscriber-side router, where the existing conventional router 1110 is relegated to use as a wide area network (WAN) 1105 interface, and the MR 1305 handles conventional subnet routing responsibilities. In FIG. 15, the existing conventional router 1110 is configured to realize a single subscriber-side LAN, and the MR 1305 will subnet that LAN into two or more subnets, each of which is a subset of the conventional router's LAN. As in the case above, the MR 1305 knows that the APs 1155-1180 and subscriber may be configured with gateway 0 (GWO) as their default gateway, and not require their reconfiguration.

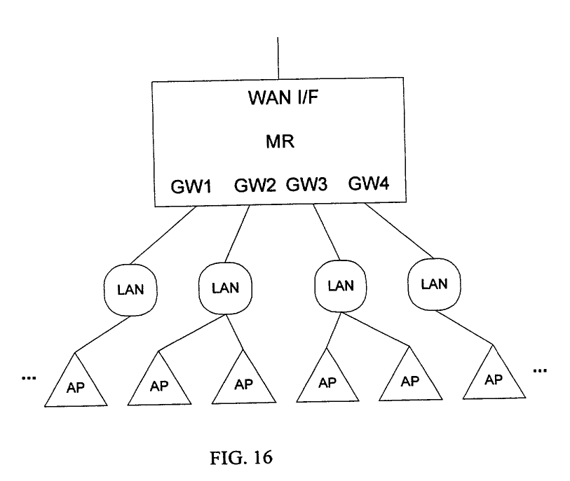

In FIG. 16, the MR 1305 is introduced as a replacement for the existing conventional router 1110, for both LAN and WAN-side duties. This implies that the MR 1305 handles any required conventional WAN-side routing protocols.

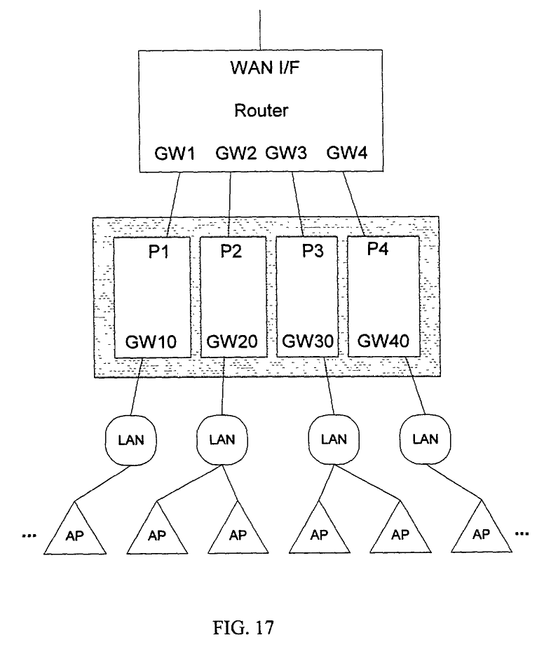

It should be appreciated that the illustrative examples described with reference to FIGS. 13-16 above may be extended to multiple-board configurations as shown in FIGS. 17-19. For instance, FIG. 17 shows an embodiment of a multiple-board equivalent of those networks illustrated in FIGS. 13 and 14. This multiple-board configuration provides increased performance over the single-board case and may provide a level of redundancy if one of the GWx-Px links fail. Messaging between the MR and the conventional router may allow reconfiguration of the failed subnet onto one of the existing healthy subnets utilizing this example.

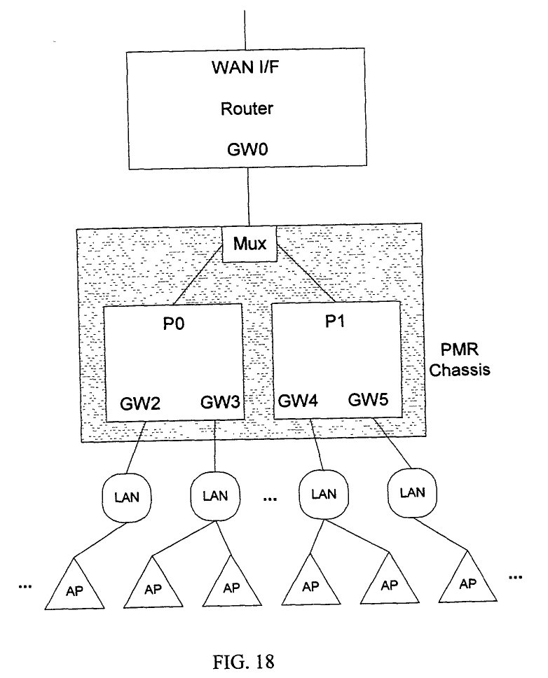

Next, it should be appreciated that the multiple-board configuration shown in FIG. 18 is also equivalent to the network illustrated in FIG. 15. Like the previous multiple board configurations, this multiple-board configuration provides increased performance over the single-board case, and may provide a level of redundancy if one of the MR boards fail. Messaging between the MR and conventional router may allow reconfiguration of the failed subnet onto one of the existing subnets.

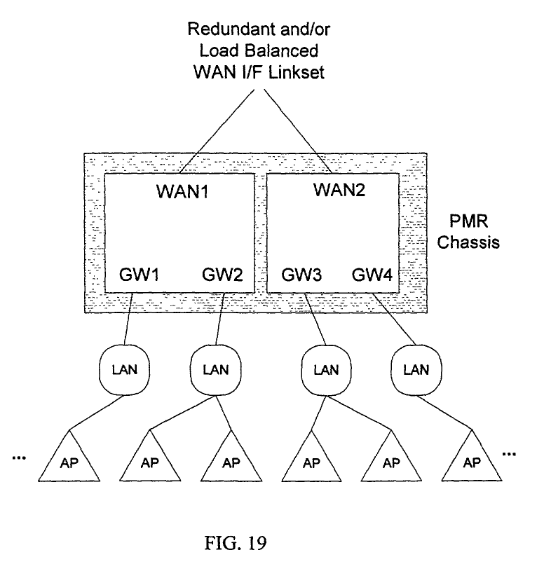

Finally, the multiple-board configuration shown in FIG. 19 is equivalent to the illustrative example shown in FIG. 16. Like the previous multiple board examples, this multiple-board chassis configuration provides increased performance over the single-board case. The MR in this example may also support multiple WAN interfaces for redundancy and/or load balancing, in which either WAN link may fail without loss of service. WAN link failures could be caused at the network interface at either end of a link, or a failure in the link itself.

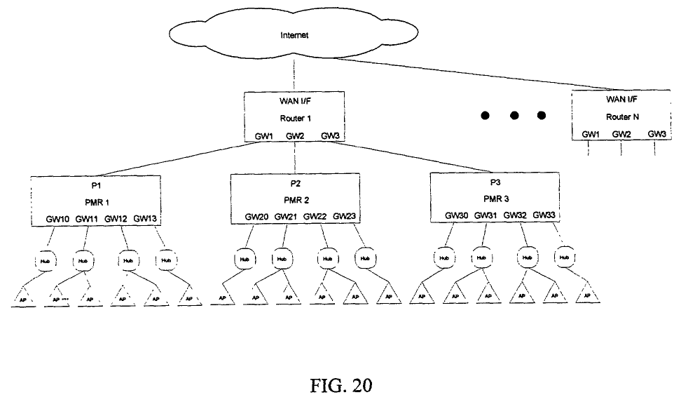

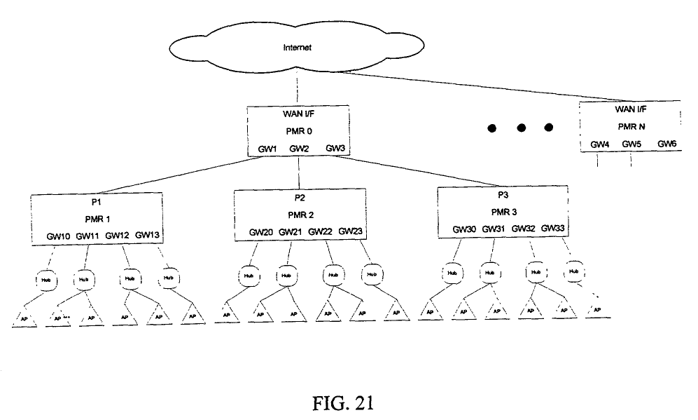

Moreover, multiple MRs may be deployed in one of several classes of multiple-MR network architectures, as illustrated in FIGS. 20-22. FIG. 20 shows a Horizontal MR Architecture. This architecture is called “horizontal” because the MRs are deployed as peers at the bottom plane of the network. FIG. 21 illustrates Hierarchical MR Architecture. This architecture is called “hierarchical” because the MRs are deployed at multiple planes in the network. MRs are deployed hierarchically to minimize horizontal tunneling of traffic, when subscribers are communicating with hosts external to the wireless network. In this example, MR provides a point of presence to the Internet, and routes incoming traffic directly to the bottom-layer MR that is currently serving a given subscriber's point of attachment.

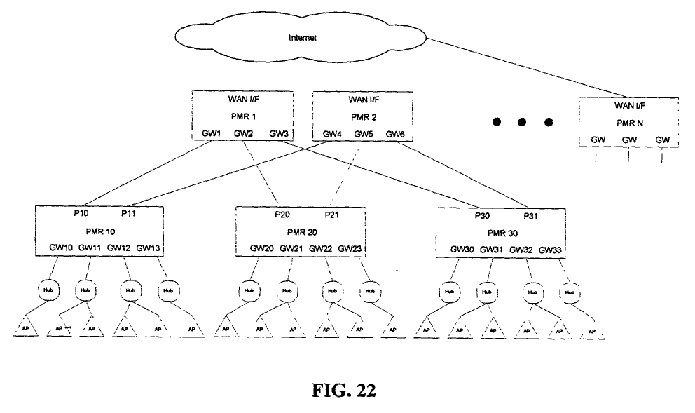

Finally, FIG. 22 illustrates a Distributed MR Architecture embodiment. This type of hierarchical MR architecture is called “distributed” because the MRs are not deployed in a simple rooted tree structure. MRs are deployed in this distributed fashion to provide fault tolerance around any single point of failure above the bottom plane, including any of the GWx-Px links.

Those of skill in the art should appreciate that LAN switches are often used in place of hubs in wireless networks to increase efficiency of wireline LANs. Therefore, LANs may be used in place of hubs in any of the above illustrative networks. However, LANs can selectively block traffic on a port basis, based on the location of hosts as sensed by the LAN switch. Therefore, LAN switches pose a potential difficulty for MR-based roaming and handoff, in that downstream traffic addressed for a given mobile station will only be allowed through to the one LAN segment that the switch has marked as currently serving that host. If a mobile station has changed points of attachment, but has not transmitted since changing points of attachment, the MR may not efficiently find the mobile station with downstream traffic.

Several alternatives exist for circumventing this potential dilemma. First, hubs may be used in place of LANs. Therefore, new LAN switches should not be placed on the MR's subscriber-side LANs. Further, the switching functionality of any existing LAN switches on the MR's subscriber-side LANs should be disabled. This allows the MR to efficiently ensure lossless, zero latency handoffs. Another method of circumventing this potential problem is by ensuring that mobile stations send a packet upstream through the LAN switch upon changing points of attachment among wireless access points. Mobile stations that send packets upstream upon changing points of attachment are identified as smart movers. This can ensure that the LAN switch always has the correct port configured for a given mobile station, again allowing the MR to ensure lossless, zero latency handoffs.

Yet another manner of circumventing potential problems encountered by LANs is through configuring the MR to use an algorithm, executed with the aid of a software application and a processor within the MR, that detects mobile stations who may have moved, by causing the hosts to send an upstream packet to get the LAN switch correctly reset. This configuration setting will cause the MR to perform a timeout-based Address Resolution Protocol (ARP) Request to be sent on all candidate subscriber LAN segments for a given mobile station that may have moved. LAN switch detection of the mobile station's location, in the absence of the case where the mobile station is still transmitting after the handoff, will depend on the mobile-host's ARP reply. This alternative can increase handoff latency, although such latency will remain within acceptable limits, as the maximum handoff latency will be the timeout period plus the ARP Request/Reply round trip time. It should be clearly appreciated that alternatives 1 or 2 provide the most efficient method of dealing with LAN switches.

To communicate with the wireless IP network mobile stations must be configured with IP addresses. According to one aspect of the invention, mobile stations may be configured with publicly reachable IP addresses so that the hosts will be able to communicate with other publicly reachable mobile stations, and with the external world via a MR network-side interface. According to another aspect of the invention, mobile stations may be configured with private IP addresses (Request For Comments [RFC] 1597), for communication primarily with other mobile stations. The use of private IP addresses may be beneficial in conserving IP addresses. The Internet Assigned Numbers Authority (IANA) has reserved the following three blocks of the IP address space for private networks: 10.0.0.0-10.255.255.255, 172.16.0.0-172.31.255.255, and 192.168.0.0-192.168.255.255. However, using a private IP address does not necessarily limit the mobile stations from communicating with publicly reachable hosts or networks, as mobile stations configured with private addresses may communicate with the external world via MR supplied Network Address Translation.

The MR may also be configured to provide Dual Host Communication Protocol (DHCP) (RFC 2131) services for automatic IP address configuration of mobile Stations. Initial DHCP address assignment can be restrained in two ways to achieve maximum network efficiency. First, the mobile station's current point of attachment may be taken into account when allocating an IP address. Secondly, some other mobile station-specific parameter, such as user or device identification, may be taken into account when allocating an IP address. These methods are provided to help minimize tunneling when the subscriber is at their home location. Subsequent DHCP lease renewals can occur correctly independent of the mobile station's point of attachment when renewing.

To increase network efficiency, MR same-subnet routing can be minimized by assigning short netmasks to mobile stations, e.g., Class B netmasks (255.255.0.0). This can minimize the potential for a mobile station to force MR routing when two communicating hosts are coresident on the same subnet. Furthermore, when assigning addresses (either static or dynamic), the mobile stations numbering scheme might reflect their home location. Private mobile station IP addresses might be provisioned, for example in a large building, as 192.168.floor/wing.ext. MR subscriber interface gateways might then be 192.168.floor/wing.1. Netmasks in this example would be 255.255.0.0. FIG. 13 shows a MR of the present invention in communication with a plurality of private hosts (or mobile stations) via a plurality of wireless access points (WAPs), according to one aspect of the present invention.

According to some embodiments, the MR provides for mobility management of mobile stations roaming throughout a plurality of networks. Presently, mobile-IP (RFC 2002-2006), which is an enhanced IP protocol, is utilized to enable mobile stations to roam transparently throughout networks while automatically maintaining IP-based connections to their home networks. As is known to those of skill in the art, Mobile-IP uses a tunneling mechanism to provide continuous delivery of packets as a mobile station moves from subnet to subnet. However, Mobile-IP suffers from a number of limitations and disadvantages. For instance, Mobile-IP requires device mobility software, device mobility messaging, device mobility processor overhead, and network mobility messaging. Furthermore, Mobile-IP introduces high bearer traffic latency, high handoff latency, some Internet incompatibility (firewalls, reverse path filtering), and triangular routing inefficiencies. The MR of the present invention offers mobility management overcoming the limitations of Mobile-IP.

Upon powering up and accessing a serving MR, a mobile host's (host) address is first checked to see if it is known from another neighboring MR, e.g., to detect a handoff. If not, the host can receive a leased DHCP address from the serving system's pool, i.e., the serving system becomes the host's current home subnet. The reason for logical centralization of the DHCP server function is that after a handoff, and while a session is established, a host may request renewal of its DHCP lease. To avoid the lease expiring and dropping the session, the serving MR renews the lease with the same DHCP address that was assigned from the host's previous subnet. Note that this established-session-during-handoff scenario is also the only time tunneling occurs between domains and triangulation is accomplished, as is well known to those of skill in the art, such as in Mobile-IP. When a renewal request is received and the host has been inactive from a TCP perspective for some period of time, it's safe to assume it can receive a new DHCP address, homed to the serving system. Therefore, the triangulation problem of Mobile-IP is avoided and minimal latency occurs.

The MR includes a Mobile Host-station Detection (MHD) algorithm that provides an efficient handoff detection algorithm. MHD avoids the registration process of Mobile-IP, wherein the subscriber has to either notice his network settings no longer work, constantly solicit for new agents, or hear a new foreign agent advertisement message, all of which take a inappropriate amount of time and processing overhead. The mobile station then has to register with the new foreign agent, have that foreign agent provide a new care-of-address, have the foreign agent register with the home agent, etc., before service can continue. In the MR MHD algorithm, new subscribers are picked up instantly so that service continues uninterrupted.

DHCP provides an acceptable mechanism for a mobile host station in a wireless network utilizing the MR of the present invention to gain initial address. New DHCP leases can be provided when a mobile station times out and seeks to renew its address, or a mobile station is being served by a subnet other than its last “home” subnet (i.e. “home” is the subnet of his current DHCP address), but remained inactive for some period of time. Since it is desirable to provide an uninterrupted end-to-end addressing paradigm for the mobile station, the existing DHCP lease should be supported after handing off to a new subnet. Only after the host has remained inactive for a period of time will the network establish that the hosts' new home is the current serving subnet.

If a mobile station can be given a new home at any time to its current serving subnet, the issue arises as to how the host will be reachable from the Internet, By implementing a new DNS root for the network's mobile stations, a wireless network including the MR of the present invention can keep the DNS dynamically updated when a mobile station rehomes to its serving network. By using an intelligent platform for both DHCP and Dynamic DNS (DDNS) services, DDNS remains current and in fall synchronization with the rehoming of mobiles. Upon receiving a handed-off subscriber, the MR will start an activity timer. As long as the user stays active, the old DHCP will continue to be renewed in the serving system, so that his end-to-end paradigm stays consistent. After some period of inactivity, it is assumed that new sessions to the mobile host can be based on the DDNS resolution to his new home network. A new DHCP is assigned, and the DNS record is modified for subsequent service request lookups, which will now resolve to the rehomed address.

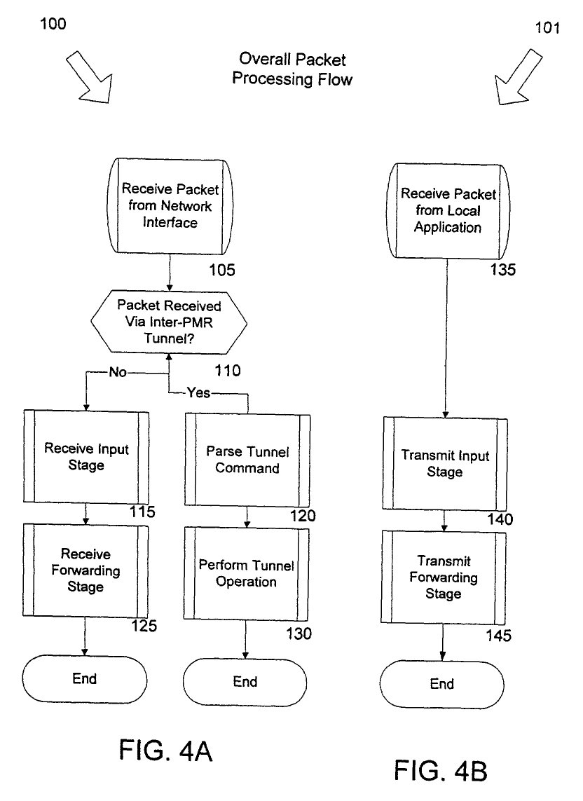

Referring now to FIGS. 4-11, flowcharts of embodiments of the above routing methods performed in accordance with the present invention are shown.

FIGS. 4A and 4B show embodiments of the overall IP packet processing flow 100 and 101 achieved by the MR. The MR first receives an IP packet from a Network Interface 105 or a local application 135. When the packet is received from a network interface, the MR determines if the packet was received via a MR tunnel in decision block 110. When the packet is received via a MR tunnel, the MR parses the tunnel command in block 120 and performs the tunnel operation in block 130. If the packet is not received from and MR tunnel the packet is sent to a Receive Input Stage 115 and then to a Receive Forwarding stage 125. When the packet is received from a local application in block 135, it is then sent to a Transmit Input Stage in block 140, then to a Transmit Forwarding Stage in block 145.

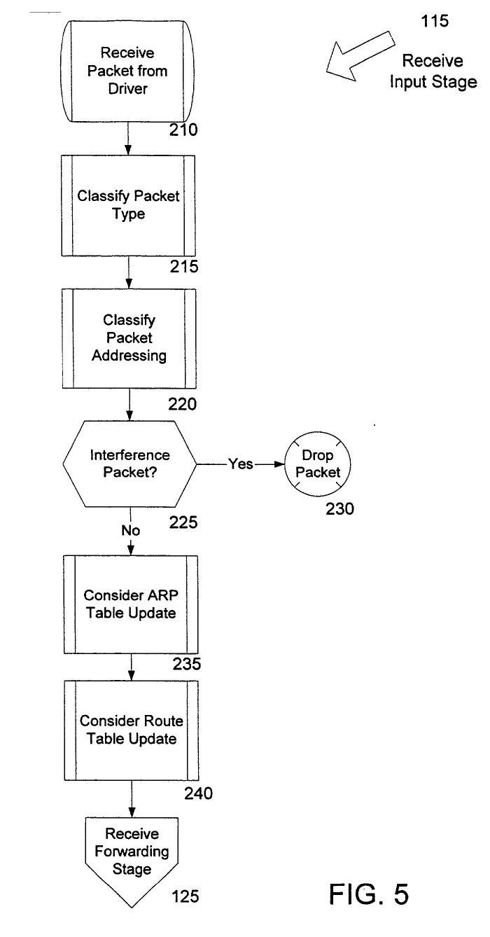

FIG. 5 shows the Receive Input Stage 115. In this stage the packet is received from a driver in block 210. The MR then classifies the packet type in block 215. The IP packet may be an Address Resolution Protocol (ARP) request packet, an ARP reply packet, or an IP packet, or a special link layer packet, which is an IP packet that comprises a hardware address.

Next the MR classifies the IP packet addressing in block 220. The IP packet address may be classified as any one of the following: a subscriber, a network, a gateway, a virtual gateway, and external address, a broadcast address, or and null address. In decision block 225, the MR then determines whether the IP packet is an interference packet. An interference packet is a packet that gets transmitted between nodes with the same network visibility. The MR drops interference packet in block 230 to avoid transmission loops. If the packet is not an interference packet, the MR considers an ARP table update in block 235. In block 240 the MR next considers a Route Table update, and then proceeds to the Receive Forwarding Stage in block 125.

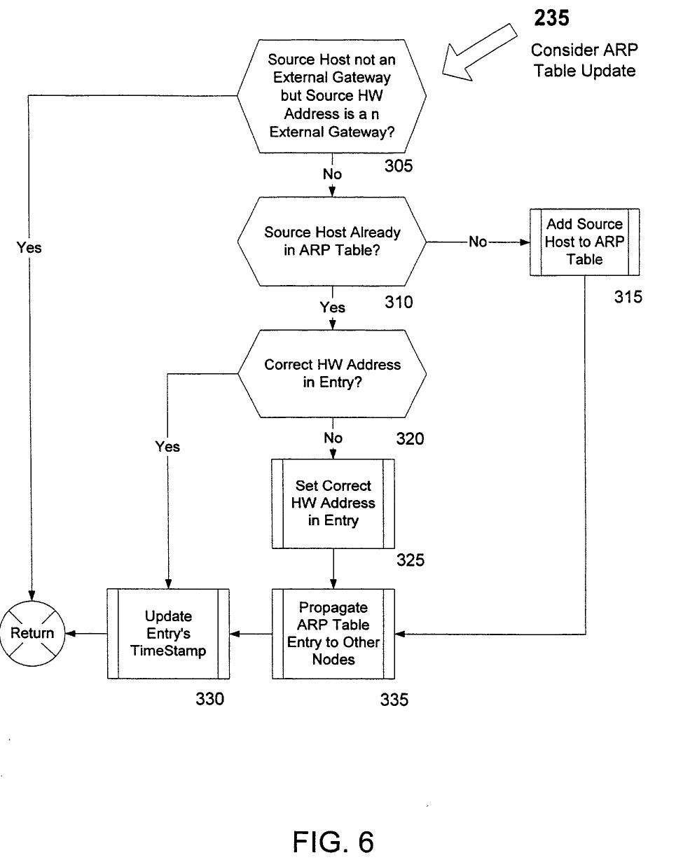

Referring now to FIG. 6, the Consider ARP Table Update Stage 235 is described. In decision block 305 the MR determines whether the source host's hardware address in an external gateway. When a negative response is received from decision block 305 the MR returns the IP packets. When the source hardware address in not an external gateway, the MR next determines whether the source host is already in the ARP table in decision block 310. When the source host is not in the ARP table, the MR adds the source host to the ARP table in block 315, propagates the ARP table entry to other nodes in block 335, and updates the entry's timestamp in block 330. When the source host is already in the ARP table, the MR determines whether it has the correct hardware address entry for the source host in decision block 320. When the hardware address entry is correct, the MR updates the entry's timestamp in block 330. When the hardware address entry is not correct, the MR sets the correct hardware address in block 325, propagates the ARP table entry to the other nodes in block 335 and updates the entry's timestamp in block 330.

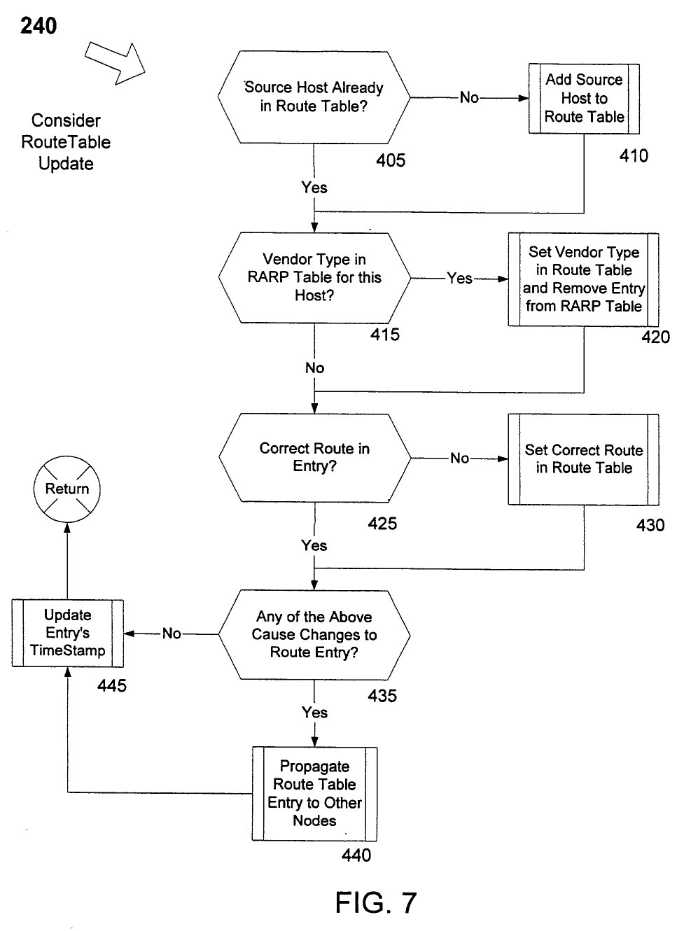

The Consider Route Table Update Stage 240 is illustrated in FIG. 7. The MR first determines whether the source host is already in the route table in block 405. When the source host is not in the route table, it is added to the route table in block 410. In block 415, the MR next determines whether the vendor type for the host is in the RARP table, which is a table to temporarily store IP packets that have hardware addresses. This determination helps the MR identify smart movers, which are hosts that automatically send IP packets to the router when they change their point of attachment to the network. When the vendor type for the particular host is in the RARP table, the MR sets the vendor type in the route table and removes the entry from the RARP Table in block 420. In decision block 425, the MR determines whether it has the correct route entry. When it does not have the correct route entry, the MR sets the correct route in the route table in block 430. In decision block 435, the MR determines whether any of the previous changes caused any changes to the route table entry. If not, the MR updates the entry's timestamp in block 445. If there were changes, the MR propagates the route table entry to other nodes using tunnel commands in block 440, and updates the entry's timestamp in 445.

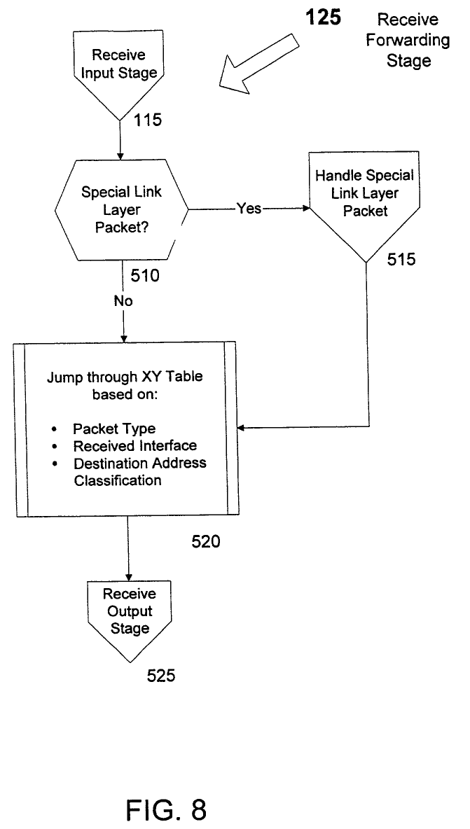

FIG. 8 illustrates the Receive Forwarding Stage 125. The MR first determines whether the packet is a special link layer packet in decision block 510. A link layer packet is an IP packet that comprises a hardware address. If the packet is a link layer packet, the MR handles the packet in the Special Link Layer Packet Stage in block 515. In block 520, when the packet is not a link layer packet, the MR searches for the classification of the packet in the route table based on the packet's type, the packet's source, and the packet's destination address.

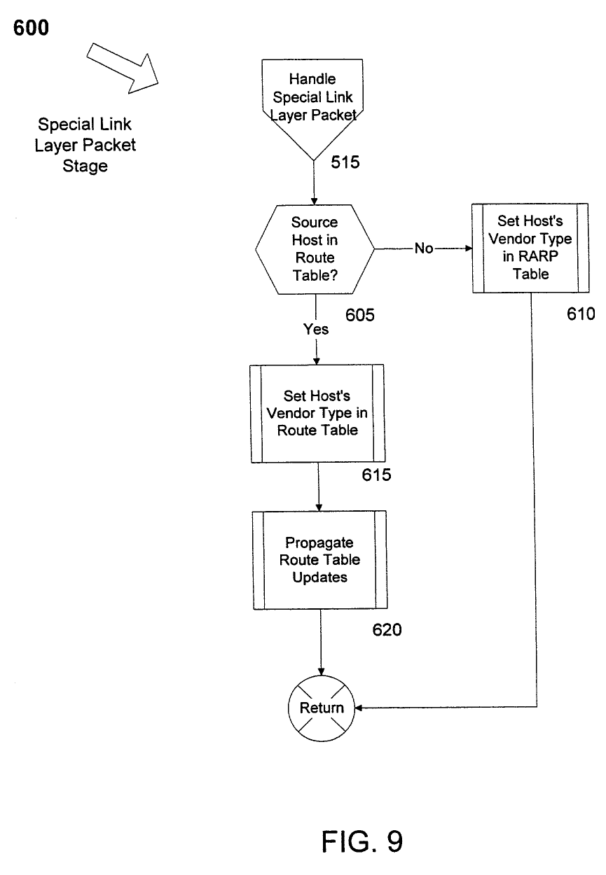

FIG. 9 shows the Special Link Layer Stage 600. In this stage, the MR first determines whether the source host is in the route table in decision block 605. When the host is not in the route table, the MR sets the host's vendor type in the RARP table in block 610. In block 615 when the host is in the route table, the MR sets the host's vendor type in the route table. The MR then propagates the route table updates to other nodes in the network in block 620.

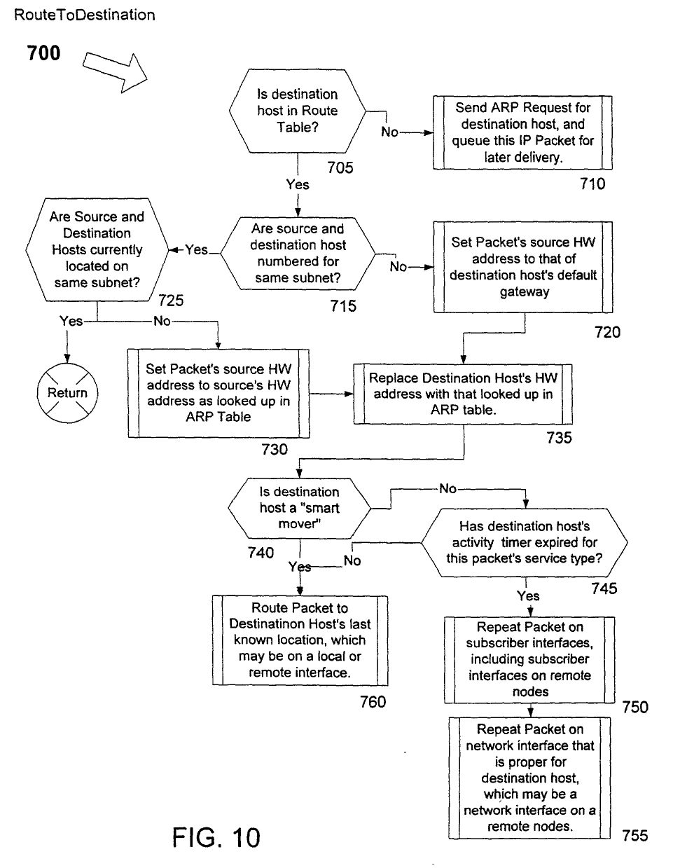

FIG. 10 illustrates the Route to Destination Stage 700. The MR first determines whether the destination host is in the route table in decision block 705. In block 710, when the destination host is not in the route table, the MR sends an ARP Request for destination host and queues the IP packet for later delivery. When the destination host is in the route table, the MR determines whether the source and destination hosts are numbered for the same subnet in decision block 715. When the source and destination host are numbered for the same subnet, the MR determines whether the source and destination hosts are currently located on the same subnet in decision block 725. When the source and destination hosts are not currently located on the same subnet the MR sets the IP packet's source hardware address to the source's hardware address as looked up in the ARP table in block 730. Next the MR replaces the destination host's hardware address with the address looked up in the ARP table in block 735. In decision block 740, the MR determines whether the host is a smart mover as defined supra. When the host is a smart mover, the MR routes the packets to the destination host's last known location in block 760. In decision block 745, when the host is not a smart mover, the MR determines whether the destination host's activity timer has expired for the particular packet's service type. In block 750, when the activity time has expired, the MR repeats the packet on subscriber interfaces, including subscriber interfaces on remote nodes. The MR then repeats the packet on the network interface that is the proper destination host in block 755. When the activity timer has not expired, the MR routes the packet to destination host's last known location.

Furthermore, in addition to the version shown in FIG. 10, there can be at least two other versions of routing IP packets to their destination. The packets may be routed the same as shown in FIG. 10, only to a mobile IP host o the network side or subscriber side.

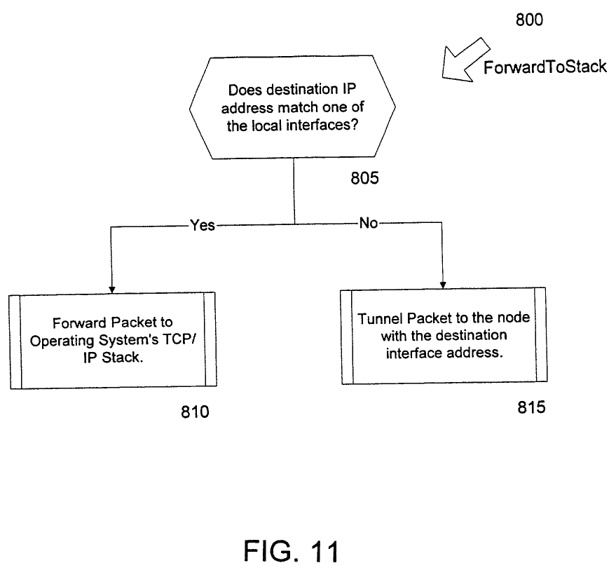

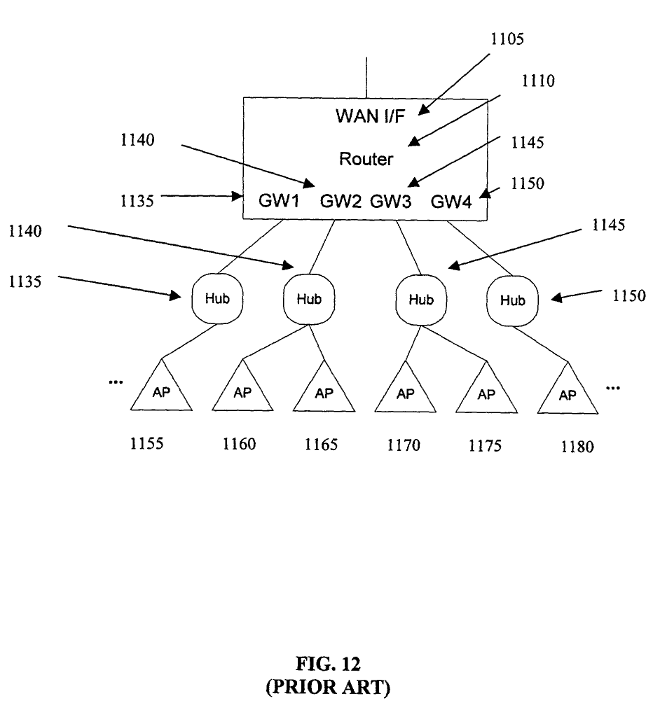

FIG. 11 shows an embodiment of the Forward to Stack stage 800 of the current invention. I decision block 805 the MR determines whether the IP packet address matches the address of one of the local network addresses. In block 810 the IP packet is forwarded to the operating system's TCP/IP stack when the decision in block 805 yields a positive answer. In block 815, when the IP packet address and one of the local network addresses do not match the IP packet is tunneled to the node with the destination interface address.

The previous description of the embodiments is provided to enable any person skilled in the art to practice embodiments of the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A method for routing Internet Protocol (IP) packets between network nodes for seamless mobile IP host subscriber service as the mobile IP host moves between network nodes comprising:
receiving the IP packets;
classifying the IP packets according to their type, source and destination; and
routing the packets to their destination address based on their classification.

2. The method of claim 1 wherein, routing the packets based on their classification comprises:
maintaining an Address Resolution Protocol (ARP) table of the classifications to map the IP addresses of the IP packets; and
maintaining an route table of the classifications to route the packets to their destination address.

3. The method of claim 1, wherein receiving IP packets is accomplished through node on the Internet, another router with a tunnel command or a local application.

4. The method of claim 3, wherein the a tunnel command is parsed and performed.

5. The method of claim 3 wherein the type of IP packets are Application Resolution Protocol (ARP) request packets, ARP reply packets, IP packets, Interference packets, or link layer packets.

6. The method of claim 4, wherein an interference packet is a packet that gets transmitted between nodes with the same network visibility.

7. The method of claim 4, wherein a link layer packet is an IP packet that has a hardware address.

8. The method of claim 1, wherein the types of destination address classifications are subscriber addresses, network addresses, internal gateway addresses, virtual gateway addresses, external addresses or broadcast addresses.

9. A method for routing Internet Protocol (IP) packets between network nodes for seamless mobile IP host subscriber service as the mobile IP host moves between network nodes comprising:
receiving the IP packets; and
sending the IP packets to a Receive Input Stage, then to a Receive Forwarding Stage when they are received from a node on the Internet.

10. The method of claim 9, wherein the Receive Input Stage comprises:
classifying the IP packet type;
classifying the IP packet addressing;
disregarding the IP packet when it is an interference packet;
considering an ARP table update; and
considering a route table update.

11. The method of claim 9, wherein the Receive forwarding Stage comprises:
determining whether the IP packet is a link layer packet;
determining whether the mobile IP host is in the route table when the IP packet is a link layer packet;
determining whether the mobile IP source host is in the route table, when the packet is a link letter packet;
setting the hosts vendor type in a RARP table when the host is not in the route table;
setting the hosts vendor type in the route table when the host is already in the route table;
propagating the route table update to other nodes in the network; and
classifying the IP packets when they are not link layer packets.

12. A method for routing Internet Protocol (IP) packets between network nodes for seamless mobile IP host subscriber service as the mobile IP host moves between network nodes comprising:
sending the IP packets to a Transmit Input Stage then to a Transmit Forwarding Stage when the packets are received from a local application.

13. The method of claim 12 wherein the Transmit Input Stage comprises determining the classification of the of the IP packet based on a route table.

14. The method of claim 12, wherein the Transmit Forwarding Stage comprises routing the IP packets to their destination based on their classification.

15. A method for routing Internet Protocol (IP) packets between network nodes for seamless mobile IP host subscriber service as the mobile IP host moves between network nodes comprising:
determining whether the IP packet was sent from a router or directly from the mobile IP host;
determining whether the host is already in an ARP table when the packet is sent directly from an IP host;
adding the IP host to the ARP table when the host is not already in the ARP table and the IP packet is sent directly from an IP host;
propagating the IP host's ARP table entry to other nodes in the network;
updating the IP host's ARP table entry timestamp;
determining whether the IP host's hardware address is correct when the IP host is already in the ARP table;
updating the IP host's ARP table entry timestamp when the IP host's hardware address is correct in the ARP table;
setting the correct hardware address entry when the IP host's hardware address is not correct in the ARP table;
propagating the IP host's ARP table entry to other nodes in the network when it is corrected in the ARP table; and
updating the IP host's entry time stamp when it is corrected and propagated;

16. A method for routing Internet Protocol (IP) packets between network nodes for seamless mobile IP host subscriber service as the mobile IP host moves between network nodes comprising:
determining whether the mobile host is already in a route table;
adding the host to the route table when the host is not already in the route table;
determining whether the vendor type for the host is in a RARP table;
setting the vendor type in the in the route table and removing the vendor type from the RARP table when the vendor type is in the RARP table;
determining whether the correct route for the IP packets is entered into the route table;
setting the correct route for the IP packets in the route table when the route is not already correct;
determining whether any changes have occurred to the route table;
propagating the updated route table entry to other nodes in the IP network using tunnel commands; and
updating the route table entry's time stamp;

17. The method of claim 16, wherein the RARP table is a table to temporarily store IP packets that have hardware addresses.

18. The method of claim 16, wherein determining whether the vendor type for the host is in the RARP table establishes whether the host sends an IP packet to the router when it changes its point of attachment to the network.

19. A method for routing Internet Protocol (IP) packets between network nodes for seamless mobile IP host subscriber service as the mobile IP host moves between network nodes comprising:
determining whether the destination IP address matches on one of the local network interfaces;
forwarding the IP packets to the network operating system's TCP/IP stack when the destination IP address matches one of the local network interfaces; and
tunneling the IP packets to the node with the destination network interface address when the destination IP address does not match on of the local network interfaces.

20. A method for routing Internet Protocol (IP) packets between network nodes for seamless mobile IP host subscriber service as the mobile IP host moves between network nodes comprising:
determining whether a destination IP host is in a route table;
sending an ARP request for the destination host and queing the IP packet for later delivery;
determining whether the source host and destination hosts are numbered for the same subnet;
setting the IP packets source hardware address to that of the destination IP host's default gateway when the source and destination host are numbered for the same subnet;
determining whether the source IP hosts and the destination IP hosts are currently located on the same subnet when they are numbered for the same subnet;
setting the IP packets source host's hardware address to a source host's hardware address as looked up in an ARP table when the source hosts and destination hosts are not currently located on the same subnet;
setting the IP packet's source hardware address to the host's default destination gateway when the source host and destination host are not numbered for the same gateway;
replacing the destination host's hardware address with the destination address looked up in the ARP table when the packet's source hardware address is set to the destination host's default gateway and when the packet's source hardware address is set to the source's hardware address as looked up in the ARP table;
determining whether the destination host is a host that sends a packet to the router when it changes it point of attachment to the network;
routing the IP packet to the destination host's last known location on a local or remote interface when the destination hosts is a host that sends a packet to the router when it changes it point of attachment to the network;
determining whether the destination hosts activity timer has expired;
routing the IP packet to destination host's last known location on a local or remote interface when the destination host's activity timer has not expired;
repeating the IP packets on subscriber interfaces when the destination hosts activity timer has expired; and
repeating packets on a network interface that is proper for the destination host.

21. An apparatus for facilitating a mobile IP host's movement within and between IP networks while maintaining a seamless IP subscriber service comprising:
a network interface;
a central processing (CPU) coupled to the network interface to facilitate routing;
a route table coupled to the CPU for determining the rout destination the IP packets based on their classification; and
Address Resolution Protocol (ARP) table coupled to the CPU to storing IP packet classifications for mapping the IP addresses of the IP packets.

22. A computer readable medium encoded with data instructions, such that when executed by a computer is caused to perform processes comprising:
receiving the IP packets;
classifying the IP packets according to their type, source and destination; and
routing the packets to their destination address based on their classification.

23. The computer readable medium of claim 22 wherein, routing the packets based on their classification is achieved, comprises:
maintaining an Address Resolution Protocol (ARP) table of the classifications to map the IP addresses of the IP packets; and
maintaining a route table of the classifications to rout the packets to their destination address.

24. The computer readable medium 22, wherein receiving IP packets is accomplished through a node on the Internet, another router with a tunnel command or a local application.

25. The computer readable medium 24, wherein the tunnel command is parsed and performed.

26. The method of claim 24 wherein the types of IP packets are Application Resolution Protocol (ARP) request packets, ARP reply packets, IP packets, Interference packets or link layer packets.

27. The computer readable medium 26, wherein an interference packet is a packet that gets transmitted between nodes with the same network visibility.

28. The computer readable medium 26, wherein a link layer packet is an IP packet that has a hardware address.

29. The computer readable medium 22, wherein the types of destination address classifications comprise:
subscriber addresses;
network addresses;
internal gateway addresses;
virtual gateway addresses;
external addresses; and
broadcast addresses.

30. A computer readable medium encoded with data instructions, such that when executed by a computer is caused to perform processes comprising:
receiving the IP packets; and
sending the IP packets to a Receive Input Stage, then to a Receive Forwarding Stage when they are received from a node on the Internet.

31. The computer readable medium 30, wherein the Receive Input Stage comprises:
classifying the IP packet type;
classifying the IP packet addressing;
disregarding the IP packet when it is an interference packet;
considering an ARP table update; and
considering a route table update.

32. The computer readable medium 30, wherein the Receive forwarding Stage comprises:
determining whether the IP packet is a link layer packet;
determining whether the mobile IP host is in the route table when the IP packet is a link layer packet;
determining whether the mobile IP source host is in the route table, when the packet is a link letter packet;
setting the hosts vendor type in a RARP table when the host is not in the route table;
setting the hosts vendor type in the route table when the host is already in the route table;
propagating the route table update to other nodes in the network; and
classifying the IP packets when they are not link layer packets.

33. A computer readable medium encoded with data instructions, such that when executed by a computer is caused to perform processes comprising:
sending the IP packets to a Transmit Input Stage then to a Transmit Forwarding Stage when the packets are received from a local application.

34. The computer readable medium 33 wherein the Transmit Input Stage comprises determining the classification of the of the IP packet based on a route table.

35. The computer readable medium 33, wherein the Transmit Forwarding Stage comprises:
routing the IP packets to their destination based on their classification.

36. A computer readable medium encoded with data instructions, such that when executed by a computer is caused to perform processes comprising:
determining whether the IP packet was sent from a router or directly from the mobile IP host;
determining whether the host is already in an ARP table when the packet is sent directly from an IP host;
adding the IP host to the ARP table when the host is not already in the ARP table and the IP packet is sent directly from an IP host;
propagating the IP host's ARP table entry to other nodes in the network;
updating the IP host's ARP table entry timestamp;
determining whether the IP host's hardware address is correct when the IP host is already in the ARP table;
updating the IP host's ARP table entry timestamp when the IP host's hardware address is correct in the ARP table;
setting the correct hardware address entry when the IP host's hardware address is not correct in the ARP table;
propagating the IP host's ARP table entry to other nodes in the network when it is corrected in the ARP table; and
updating the IP host's entry time stamp when it is corrected and propagated;

37. A computer readable medium encoded with data instructions, such that when executed by a computer is caused to perform processes comprising:
determining whether the mobile host is already in a route table;
adding the host to the route table when the host is not already in the route table;
determining whether the vendor type for the host is in a RARP table;
setting the vendor type in the in the route table and removing the vendor type from the RARP table when the vendor type is in the RARP table;
determining whether the correct route for the IP packets is entered into the route table;
setting the correct route for the IP packets in the route table when the route is not already correct;
determining whether any changes have occurred to the route table;
propagating the updated route table entry to other nodes in the IP network using tunnel commands; and
updating the route table entry's time stamp;

38. The computer readable medium 37, wherein the RARP table is a table to temporarily store IP packets that have hardware addresses.

39. The computer readable medium 37, wherein determining whether the vendor type for the host is in the RARP table establishes whether the host sends an IP packet to the router when it changes its point of attachment to the network.

40. A computer readable medium encoded with data instructions, such that when executed by a computer is caused to perform processes comprising:
determining whether the destination IP address matches on one of the local network interfaces;
forwarding the IP packets to the network operating system's TCP/IP stack when the destination IP address matches one of the local network interfaces; and
tunneling the IP packets to the node with the destination network interface address when the destination IP address does not match on of the local network interfaces.

41. A computer readable medium encoded with data instructions, such that when executed by a computer is caused to perform processes comprising:
determining whether a destination IP host is in a route table;
sending an ARP request for the destination host and queuing the IP packet for later delivery;
determining whether the source host and destination host are numbered for the same subnet;
setting the IP packets source hardware address to that of the destination IP host's default gateway when the source and destination host are numbered for the same subnet;
determining whether the source IP hosts and the destination IP hosts are currently located on the same subnet when they are numbered for the same subnet;
setting the IP packets source host's hardware address to a source host's hardware address as looked up in an ARP table when the source hosts and destination hosts are not currently located on the same subnet;
setting the IP packet's source hardware address to the host's default destination gateway when the source host and destination host are not numbered for the same gateway;
replacing the destination host's hardware address with the destination address looked up in the ARP table when the packet's source hardware address is set to the destination host's default gateway and when the packet's source hardware address is set to the source's hardware address as looked up in the ARP table;
determining whether the destination host is a host that sends a packet to the router when it changes it point of attachment to the network;
routing the IP packet to the destination host's last known location on a local or remote interface when the destination hosts is a host that sends a packet to the router when it changes it point of attachment to the network;
determining whether the destination hosts activity timer has expired;
routing the IP packet to destination host's last known location on a local or remote interface when the destination host's activity timer has not expired;
repeating the IP packets on subscriber interfaces when the destination hosts activity timer has expired; and
repeating packets on a network interface that is proper for the destination host.
